(19) United States
(12) Patent Application Publication
(10) Pub. No.: US 2006/0250382 A1
(43) Pub. Date: Nov. 9, 2006

(54) Optical drive having light emitting diode indicator with variable brightness

(75) Inventors: Kuo-Chun Lee, Jiangsu (CN); Quan-Wei Chen, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/395,180

(22) Filed: Apr. 3, 2006

(30) Foreign Application Priority Data
Apr. 15, 2005 (TW) 94111990

(51) Int. Cl. G09G 5/00

(52) U.S. Cl. 345/184

(57) ABSTRACT

An optical drive having LED indicator with variable brightness. The optical drive comprises a light emitting diode indicator with variable brightness and a volume knob. The brightness of the light emitting diode indicator varies with the volume of the optical drive when the volume knob is rotated. The LED indicator can be disposed on a front panel of the optical drive or directly disposed in the volume knob.

### BACKGROUND

The invention relates to an optical drive with a light emitting diode (LED) indicator, and in particular to an optical drive with a LED indicator varying brightness according to volume.

Typically, an LED indicator is disposed on the front panel of an optical drive to indicate data reading or writing to the disc.

### SUMMARY

An embodiment of an optical drive comprises a light emitting diode indicator and a volume knob. The brightness of the LED indicator is varied with volume of the optical drive when the volume knob is rotated. The optical drive further comprises a front panel on which the LED indicator and the knob are disposed.

The invention further comprises a first resistor and a second resistor, wherein the first resistor connected to the volume knob and a speaker and the second resistor connected to the volume knob and coupled to the light emitting diode. The volume knob is rotated to vary the resistance thereof so as to adjust volume and vary the brightness of the LED indicator. The first and second resistors can be circular and concentrically disposed.

The invention further comprises a first slide bar and a second slide bar. The first and second resistors are connected to the volume knob by the first and second slide bars respectively, and the first and second slide bars rotate with respect to the center of the volume knob when the volume knob is rotated.

In some embodiments of the optical drive, the volume knob is transparent, and light from the LED indicator is concentrated to the volume knob. The LED indicator can be disposed in the volume knob.

### BRIEF DESCRIPTION OF THE DRAWINGS

The invention can be more fully understood by reading the subsequent detailed description and examples with references made to the accompanying drawings, wherein:

FIG. 1 is a schematic view of a front panel of an embodiment of an optical drive of the invention;

FIG. 2 is a schematic view of the inner structure of a volume knob of an embodiment of the optical drive of the invention;

FIG. 3 is a schematic view depicting a circuit controlling the brightness of an LED indicator of an optical drive of the invention; and

FIG. 4 is a schematic view depicting a front panel of another embodiment of an optical drive of the invention.

### DETAILED DESCRIPTION

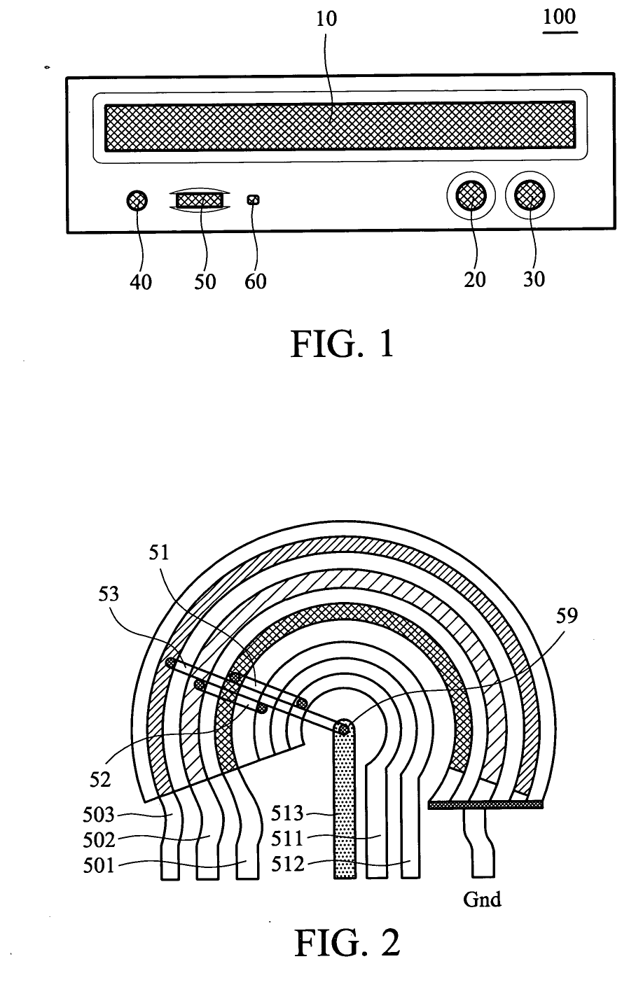

FIG.1 depicts a front panel of an embodiment of an optical drive of the invention. The front panel 100 comprises a eject slot 10, a play button 20, an eject button 30, an earphone hole 40, a volume knob 50 and a LED indicator 60. As the brightness of the LED indicator 60 is varied with the rotation of the volume knob, certain elements capable of adjusting the brightness of the LED indicator 60 are added into the volume knob 50. FIG. 2 depicts the inner structure of the volume knob 50 the volume knob 50 comprises first resistors 501 and 502, a second resistor 503, first terminals 511 and 512, a second terminal 513, first slide bars 51 and 52, and a second slide bar 53. The first resistors 501 and 502 are used for volume adjustment, and the second resistor 503 is used to adjust the brightness of the LED indicator. The first resistors 501 and 502 and the second resistor 503 are circular and concentrically disposed with one end connecting to a power supply (not shown) and the other end to ground. The first resistors 501 and 502 are electrically connected to the first terminals 511 and 512 by the first slide bar 51 and 52. The second resistor 503 is electrically connected to the second terminal 513 by the second slide bar 53. A control device (not shown) outside the volume knob 50 reads the resistance value via the first terminals 511 and 512 and the second terminal 513. When the volume knob 50 is rotated, the first and second slide bars 51, 52 and 53 rotate around the axis 59 simultaneously at which time the voltage values read via the first and second terminals 511, 512 and 513 are varied, thereby adjusting the volume and brightness of the LED indicator 60. The resistance value of the second resistor 503 is greater than 0 ohms and smaller than 50,000 ohms.

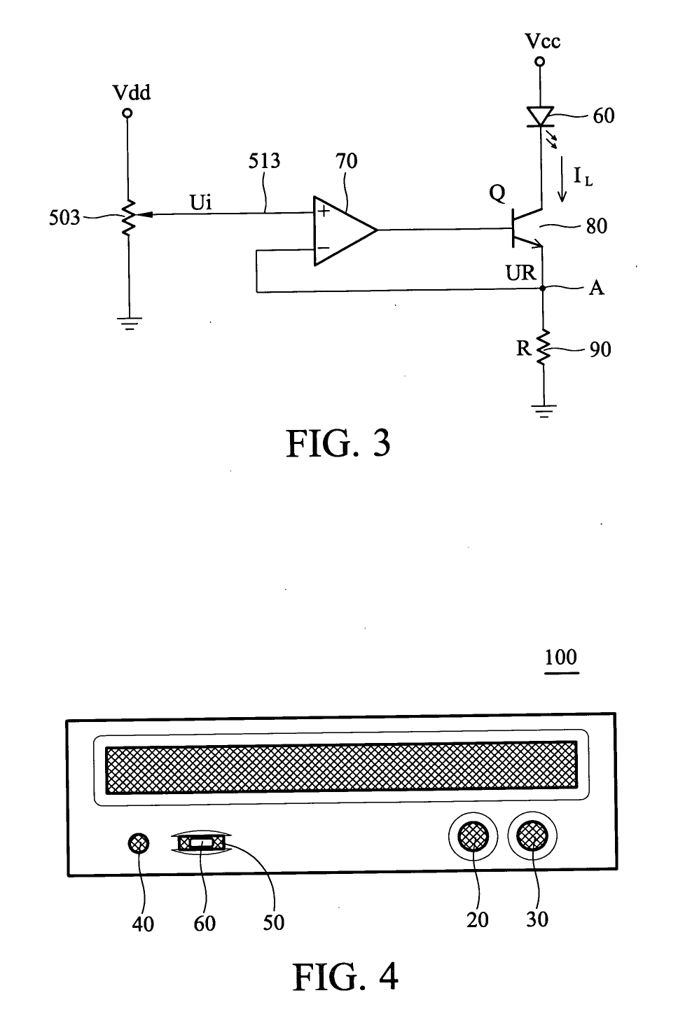

FIG. 3 depicts an embodiment of a circuit for brightness control of the LED indicator 60. The voltage read from the second terminal 513 is sent to a comparer 70. One end of the LED indicator 60 is connected to a power supply, and the other end is connected to a transistor 80. The base of the transistor 80 is connected to the output of the comparer 70, the collector connected to the LED indicator 60, and the emitter grounded via a resistor 90 of resistance value R. Voltage Ur of node A is read by the comparer 70 and compared with the voltage Ui of the second terminal 513. A control signal is output to the base of the transistor 80 by the comparer 70 to vary current I_{L} passing through the LED indicator 60. Because I_{L}=Ur/R=Ui/R, I_{L} can vary continuously with the voltage Ui, that means the brightness of the LED indicator 60 is varied continuously with the second slide bar 53 sliding on the second resistor 503. When the volume knob 50 is rotated, the volume and the brightness of the LED indicator 60 are varied simultaneously.

The LED indicator 60 can be disposed on the front panel 100 and can also be disposed in the volume knob 50 which is made of transparent material as shown in FIG. 4. When the volume knob 50 is rotated, light of variable brightness can be emitted therefrom.

In addition, to indicate the state of data reading on a disc, Vdd can be connected to an adjustable level. When the volume is adjusted, the level outputs a high level signal; when data on a disc is read, the level output is a periodic square wave. Thus, the volume adjustment and data reading can be indicated as different states.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical drive, comprising:
a light emitting diode indicator with variable brightness; and
a volume knob, wherein the brightness of the light emitting diode indicator is varied with volume of the optical drive when the volume knob is rotated.

2. The optical drive as claimed in claim 1 further comprising a front panel on which the light emitting diode indicator is disposed.

3. The optical drive as claimed in claim 2, wherein the volume knob is disposed on the front panel.

4. The optical drive as claimed in claim 1 further comprising:
a first resistor connected to the volume knob, wherein the volume knob is rotated to vary the resistance thereof so as to adjust volume; and
a second resistor connected to the volume knob and coupled to the light emitting diode indicator, wherein the brightness of the light emitting diode is varied when the volume knob is rotated.

5. The optical drive as claimed in claim 4 further comprising a first slide bar and a second slide bar, wherein the first and second resistors are connected to the volume knob by the first and second slide bars respectively, and the first and second slide bars rotate with respect to the center of the volume knob when the volume knob is rotated.

6. The optical drive as claimed in claim 4, wherein the first and second resistors are circular and concentrically disposed.

7. The optical drive as claimed in claim 4, wherein the resistance of the second resistor is larger than 0 ohms and smaller than 50,000 ohms.

8. The optical drive as claimed in claim 1, wherein the volume knob is transparent, and light from the light emitting diode indicator is concentrated to the volume knob.

9. The optical drive as claimed in claim 8, wherein the light emitting diode indicator is disposed in the volume knob.

10. The optical drive as claimed in claim 8 further comprising a front panel on which the volume knob is disposed.

11. The optical drive as claimed in claim 9 further comprising a front panel on which the volume knob is disposed.
